(19) United States
(12) Patent Application Publication
(10) Pub. No.: US 2012/0191598 A1
(43) Pub. Date: Jul. 26, 2012

(54) JOINT CLOSED-LOOP AND OPEN-LOOP INSTRUMENT ISSUANCE FOR DISBURSING FUNDS

(75) Inventors: Pedro Jose Marzo, Washington, DC (US); Daniel Scott Gretz, Crofton, MD (US); Jeffrey Todd Staples, Aldie, VA (US); David Bruce Marr, Scottsdale, AZ (US)

(73) Assignee: BLACKBOARD INC., Washington, DC (US)

(21) Appl. No.: 13/012,726

(22) Filed: Jan. 24, 2011

(51) Int. Cl. G06Q 40/00; G06Q 20/00

(52) U.S. Cl. 705/39; 235/380

(57) ABSTRACT

A system for disbursing funds is described. The system includes a memory for storing cardholder information and a processor. The processor is configured to receive a cardholder identification, to receive a unique identifier from an instrument used for purchasing at least one of goods and services, to associate the unique identifier with the cardholder information based on the received cardholder identification, and to send the unique identifier and the cardholder information to a server. Methods and machine-readable storage media are also described.

### BACKGROUND

1. Field

The present disclosure generally relates to financial account systems, and particularly to issuing instruments for financial accounts.

2. Description of the Related Art

The United States Department of Education provides billions of dollars to assist students and families in paying for postsecondary education. Students receive much of this money as financial aid in the form of loans, grants or work-study. Students often have a difficult time accessing financial aid money due to various administrative difficulties. For example, financial aid and work-study wages are often issued in the form of a check to a student by an institution, such as a state government, federal government, or university. In order to deposit the check, the student must provide appropriate identification and have a financial account in which the financial aid funds from the check can be deposited. A student who has recently arrived at an educational institution has many responsibilities and tasks to complete, such that obtaining and providing the appropriate identification to receive the financial aid becomes burdensome. Furthermore, governmental laws and industry regulations often restrict financial institutions from marketing on campus, thereby making it more difficult for students to find and locate a financial institution at which to open a financial account once they have obtained the appropriate identification to receive their financial aid check.

### SUMMARY

The present disclosure provides a solution in which a single instrument is usable by a cardholder at an institution (e.g., student, faculty or staff) as an access and identification card as well as a way for the cardholder to access his/her disbursed financial aid/payroll funds to make purchases of goods and services within an open loop environment for “allowable” charges related to the institutions' cost of attendance (e.g., at any merchant accepting transactions from the provider of the FDIC insured financial account holding the funds) and in a closed loop environment (e.g., for funds held in an institutional account and used at pre-selected merchants identified by the institution). The disclosed systems and methods provide for issuing the instruments to cardholders at the institution without subjecting the institution to many governmental laws and industry regulations that would otherwise regulate issuance of financial instruments to cardholders.

According to certain embodiments of the present disclosure, a system for disbursing funds is provided. The system includes a memory for storing cardholder information and a processor. The processor is configured to receive a cardholder identification, to receive a unique identifier from an instrument used for purchasing at least one of goods and/or services, to associate the unique identifier with the cardholder information based on the received cardholder identification, and to send the unique identifier and the cardholder information to a server.

According to certain embodiments of the present disclosure, a method for disbursing funds is provided. The method includes receiving cardholder identification and receiving a unique identifier from an instrument used for purchasing at least one of goods and/or services. The method also includes associating, using a processor, the unique identifier with cardholder information stored in memory based on the received cardholder identification, and sending the unique identifier and the cardholder information to a server.

According to certain embodiments of the present disclosure, a machine-readable storage medium including machine-readable instructions for causing a processor to execute a method for disbursing funds is provided. The method includes receiving a cardholder identification and receiving a unique identifier from an instrument used for purchasing at least one of goods and services. The method also includes associating, using a processor, the unique identifier with cardholder information stored in memory based on the received cardholder identification, and sending the unique identifier and the cardholder information to a server.

According to certain embodiments of the present disclosure, a system for disbursing funds is provided. The system includes a memory for storing a financial account identifier associated with a financial account, and a processor. The processor is configured to receive a unique identifier of an instrument used for purchasing at least one of goods and services, to receive cardholder information associated with a cardholder, to associate the cardholder information with the financial account identifier based on the received unique identifier, and to activate access to the financial account by the cardholder based on the association of the cardholder information with the financial account identifier. The financial account identifier and the unique identifier are different.

According to certain embodiments of the present disclosure, a method for disbursing funds is provided. The method includes receiving a unique identifier of an instrument used for purchasing at least one of goods and/or services and receiving cardholder information associated with a cardholder. The method also includes associating, using a processor, the cardholder information with a financial account identifier stored in memory based on the received unique identifier, and activating access to the financial account by the cardholder based on the association of the cardholder information with the financial account identifier. The financial account identifier and the unique identifier are different.

According to certain embodiments of the present disclosure, a machine-readable storage medium including machine-readable instructions for causing a processor to execute a method for disbursing funds is provided. The method includes receiving a unique identifier of an instrument used for purchasing at least one of goods and services and receiving cardholder information associated with a cardholder. The method also includes associating, using a processor, the cardholder information with a financial account identifier stored in memory based on the received unique identifier, and activating access to the financial account by the cardholder based on the association of the cardholder information with the financial account identifier. The financial account identifier and the unique identifier are different.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplary architecture for disbursing funds to a financial account instrument in accordance with certain embodiments.

FIG. 2 is an exemplary financial account instrument for use by the client of FIG. 1.

FIG. 3 is an exemplary process for disbursing funds to a financial account instrument in accordance with the architecture of FIG. 1.

FIG. 4 is a block diagram illustrating an example of a computer system with which the client and server of FIG. 1 can be implemented.

### DETAILED DESCRIPTION

In the following detailed description, numerous specific details are set forth to provide a full understanding of the present disclosure. It will be obvious, however, to one ordinarily skilled in the art that the embodiments of the present disclosure may be practiced without some of these specific details. In other instances, well-known structures and techniques have not been shown in detail not to obscure the disclosure.

While many examples are provided herein in the context of an educational institution, the principles of the present disclosure contemplate other types of organizations as well. For example, corporations and governmental entities (e.g., administrative or military) are all considered within the scope of the present disclosure. An institution may also be a consortium of schools and/or campuses. In general terms, an institution is an operating unit and is, itself, made up of different operating units that may correspond to campuses, colleges, departments, sub-departments, etc. The systems and methods described herein do not require any particular arrangement of operating units but, instead, allow the institution to model its organization into a hierarchy of operating units for purposes of management, planning, and reporting. Furthermore, although the examples refer to a cardholder (e.g., a student) in the context of an educational institution, the principles of the present disclosure contemplate that any person or user can interchangeably replace the cardholder.

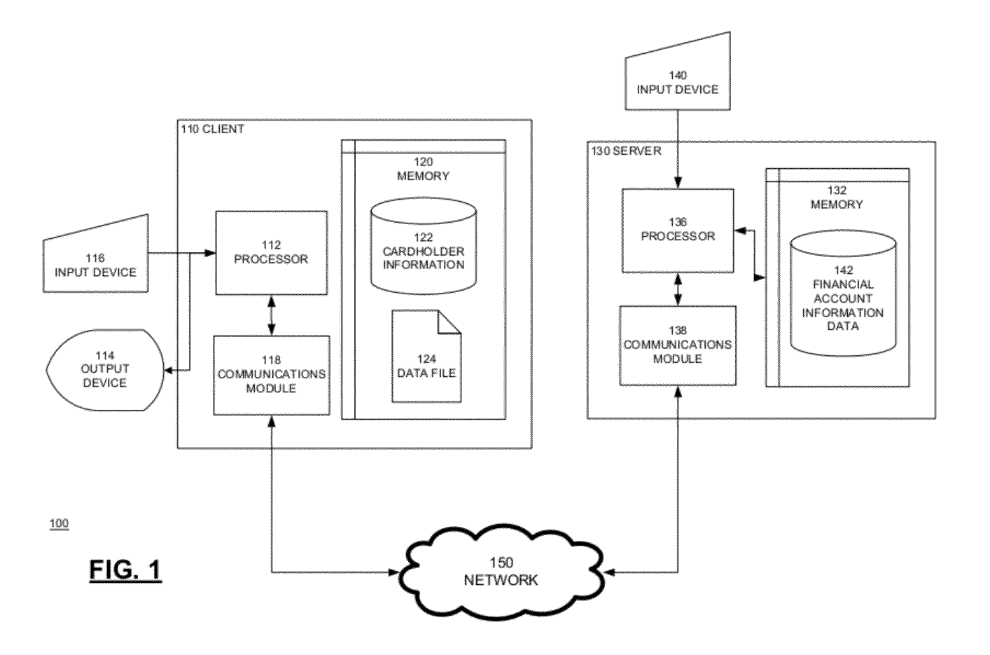

FIG. 1 illustrates an exemplary architecture 100 for disbursing funds in accordance with certain embodiments. The architecture includes a client 110 and a server 130. The client 110 is connected to the server 130 over a network 150 via respective communications modules 118 and 138. The network 150 can include, for example, any one or more of a personal area network (PAN), a local area network (LAN), a campus area network (CAN), a metropolitan area network (MAN), a wide area network (WAN), a broadband network (BBN), the Internet, or the like. Further, the network 150 can include, but is not limited to, for example, any one or more of the following network topologies, including a bus network, a star network, a ring network, a mesh network, a star-bus network, tree or hierarchical network, or the like. The communications modules 118 and 138 can be, for example, modems or Ethernet cards.

The client 110 can be, for example, a desktop computer, a mobile computer, a mobile device, a card reader, or any other device having an appropriate processor 112, memory 120, communications module 118, output device 114 and input device 116. In certain embodiments, the client 110 is physically located at an educational institution.

The client 110 includes a processor 112, the communications module 118, and a memory 120 that includes cardholder information 122 and a data file 124. The memory 120 stores cardholder information 122, such as, but not limited to, dates of birth, cardholder identification numbers, names, mailing addresses, phone numbers, and email addresses. In certain embodiments, the cardholder information 122 is included in a database, such as a transaction system database as used in Blackboard Inc.'s Transact™ Platform, and/or the systems, memories, and/or databases disclosed in U.S. patent application Ser. No. 12/559,353 entitled “Distributed Service Point Transaction System,” filed Sep. 14, 2009, and U.S. patent application Ser. No. 12/476,136 entitled “Electronic Transactions System” filed Jun. 1, 2009, the entireties of which are incorporated herein by reference. In certain embodiments, the cardholder information 122 can be located on another device, such as a local server or local storage device coupled to the client 110, either directly or over a network (e.g., network 150)

The processor 112 of the client 110 is configured to execute instructions, such as instructions physically coded into the processor 112, instructions received from software in memory 120, or a combination of both. For example, the processor 112 of the client 110 is configured to execute instructions causing it to receive a cardholder identification, such as, but not limited to, a cardholder's name, identification number, or social security number. In certain embodiments, the cardholder identification is received using an input device 116, such as a barcode reader, radio frequency identification (RFID) reader, contactless Near Field Communications (NFC) reader, magnetic stripe reader, or desktop card encoder, used, for example, to read an identification card (e.g., student identification card, driver's license, etc.). The input device 116 may also be a keyboard, microphone, touch screen display, microphone, or other appropriate device used to enter cardholder identification provided by a cardholder (e.g., in response to a cardholder stating his name, the cardholder's name can be entered using the input device 116).

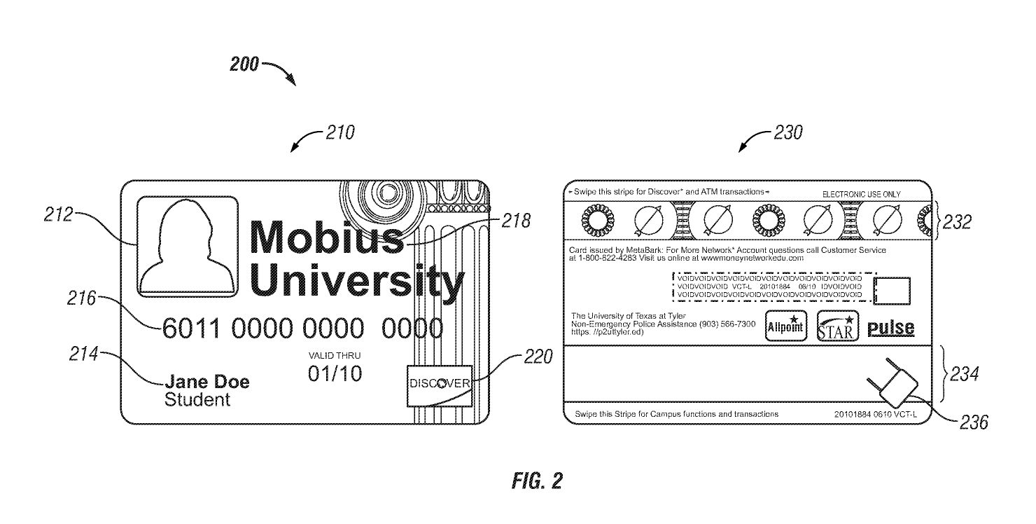

FIG. 2 illustrates an exemplary instrument 200 used for purchasing goods and/or services. The processor 112 of FIG. 1 is configured to execute instructions causing it to receive a unique identifier from the instrument 200. In certain embodiments, the unique identifier is, for example and without limitation, a group of numbers, a group of characters, a binary value, a numeric value, or any alphanumeric combination of characters. An exemplary unique identifier is “12345671.” The instrument 200 is an object that stores the unique identifier and a financial account identifier, and is used for purchasing goods and/or services. For example, the instrument 200 can be a credit, debit card, prepaid card, stored value card, or a chip. In certain embodiments, the instrument 200 is a mobile device.

In the illustrated embodiment, the instrument 200 is a physical card that includes, on a first side 230, a first information storage 232 that is a magnetic stripe (or “open-loop” magnetic stripe) in the depicted exemplary embodiment. The first information storage 232 is configured to store the financial account identifier. The first side 230 also has a second information storage 234 that is an independent magnetic stripe (or “closed-loop” magnetic stripe) in the depicted exemplary embodiment. The second information storage 234 is configured to store the unique identifier. In certain embodiments, the instrument 200 also includes a proximity chip or contactless chip (e.g., an RFID tag) 236 that can be used, for example, to grant access to physical spaces at the institution (e.g., based on access privileges granted by the transaction system database identified above) or for closed loop payments.

A second side 210 of the instrument 200 includes, in certain embodiments, one or more of: an identification 218 of the institution, a photograph identifier 212 of the cardholder, the cardholder's name and designation 214, the financial account identifier and expiration date 216 of the financial account associated with the financial account identifier, and the financial institution 220 responsible for managing access to the financial account. In certain embodiments, the instrument 200 is an electronic key fob including appropriate passive authentication identifiers, such as RFID tags or NFC identifiers, for providing the unique identifier and/or the financial account identifier.

The disclosed systems and methods do not require that the institution read or otherwise obtain any information on the financial account (e.g., the financial account identifier 216), thereby avoiding subjecting the institution to certain state and federal laws and industry regulations (e.g., Payment Card Industry (PCI) compliance) governing the disbursement of funds to students. To the contrary, the disclosed systems and methods are in compliance with many governing state and federal laws and industry regulations.

Returning to FIG. 1, in certain embodiments, the processor 112 is configured to remove the unique identifier from the instrument 200 (e.g., from the second information storage 234 using an output device 114, such as but not limited to a magnetic stripe card writer) after the unique identifier is received. In these embodiments, the processor 112 may then write a closed loop identifier to the instrument 200 (e.g., in the second information storage 234 using the output device 114, such as but not limited to a magnetic stripe card writer), such as an alphanumeric combination of characters unique to, and designated for, the institution (e.g., a student account number).

The processor 112 is further configured to associate the unique identifier with the cardholder information 122 based on the received cardholder identification. For example, if the received cardholder identification identifies a student “John Doe,” and an entry for “John Doe” exists in the cardholder information 122, then the unique identifier “12345671” (received with the cardholder identification “John Doe”) will be associated with the entry for “John Doe” in the cardholder information 122. In certain embodiments, the unique identifier and the cardholder information are stored in the data file 124 in the memory 120 of the client 110. This advantageously allows for maintaining a record that associates unique identifiers with cardholders, which is useful in a situation where, for example, a cardholder loses his instrument 200 and a replacement instrument can be issued immediately (a.k.a. “instant issuance”). For example, in the memory 120, the entry for the old unique identifier for the cardholder is replaced with a new unique identifier from the replacement instrument, and the cardholder information 122 is transmitted to processor 112 in order to move balances to the replacement instrument. The replacement can be issued “on-site” (e.g., on the campus of the institution)

The processor 112 is yet further configured to send the unique identifier and the cardholder information to the server 130. Although in the illustrated embodiment the server 130 is shown separate from the client 110, in certain embodiments the server 130 and the client 110 may be the same device. In certain embodiments, the unique identifier and the cardholder information are sent to the server 130 over the network 150 via a secure communications protocol, such as by MessageWay. In certain embodiments, the unique identifier and the cardholder information are sent to the server 130 over the network 150 in an encrypted file (e.g., using Pretty Good Privacy (PGP) or GNU Privacy Guard (GPG) data encryption) via a Secure File Transfer Protocol (SFTP) site. Specifically, the encrypted file, which can include the unique identifier and the cardholder information for one or many cardholders, can be placed on an SFTP site using the network 140, and the server 130 can retrieve and decrypt the file from the SFTP site over the network 150 using the appropriate decryption information (e.g., PGP or GPG public key). In certain embodiments, the unique identifier and the cardholder information are sent to the server 130 over the network 150 directly via an appropriate Application Programming Interface (API) with or without batch processing or a staging area.

Turning to the server 130, the server 130 can be, for example, a desktop computer, a mobile computer, a mainframe computer, or any other device having an appropriate processor 136, memory 132, communications module 138, and input device 140. In certain embodiments, the client 110 is physically located at a financial institution (e.g., bank, lending house, or credit card office). In certain embodiments, the financial institution is responsible for providing the instrument 200 (e.g., distributing the cards to cardholders or institutions).

The server 130 includes a processor 136, the communications module 138, and a memory 132 that includes financial account information data 142. The financial account information includes financial account identifiers 216 (e.g., of the financial account numbers) associated with respective financial accounts. The financial account information data 142 includes the financial account identifier 216 from the instrument 200, and further includes an association between the financial account identifier 216 and the unique identifier stored on the instrument 200 because, for example, the financial institution may have provided the instrument 200 that originally included both the financial account identifier 216 and the unique identifiers. The financial account identifier and the unique identifier are different identifiers.

The processor 136 of the server 130 is configured to execute instructions, such as instructions physically coded into the processor 136, instructions received from software in memory 132, or a combination of both. For example, the processor 136 of the server 130 is configured to receive the unique identifier of the instrument 200 and the cardholder information associated with a cardholder from the client 110. The unique identifier of the instrument 200 and the cardholder information can be received, for example, from the SFTP site or API discussed above. The processor 136 is also configured to associate the cardholder information with the financial account identifier 216 based on the received unique identifier. For example, because the financial account identifiers are already associated with the corresponding unique identifiers in the financial account information data 142, then the cardholder information that is received from the client 110 and already associated with one of the unique identifiers is then associated with the financial account identifier 216 associated with that same unique identifier in the financial account information data 142. The processor 136 is further configured to activate access to the financial account by the cardholder based on the association of the cardholder information with the financial account identifier 216. For example, once the processor 136 associates the cardholder information, which may include a cardholder's date of birth, to the financial account identifier 216 (e.g., for the financial account number), the financial account is established and made pre-active such that the cardholder can deposit or withdraw funds from the financial account. In certain embodiments, the financial account is made active after the cardholder calls the financial institution (via input device 140) and requests that the financial account be activated, such as by the cardholder dialing an activation code when calling the server 130.

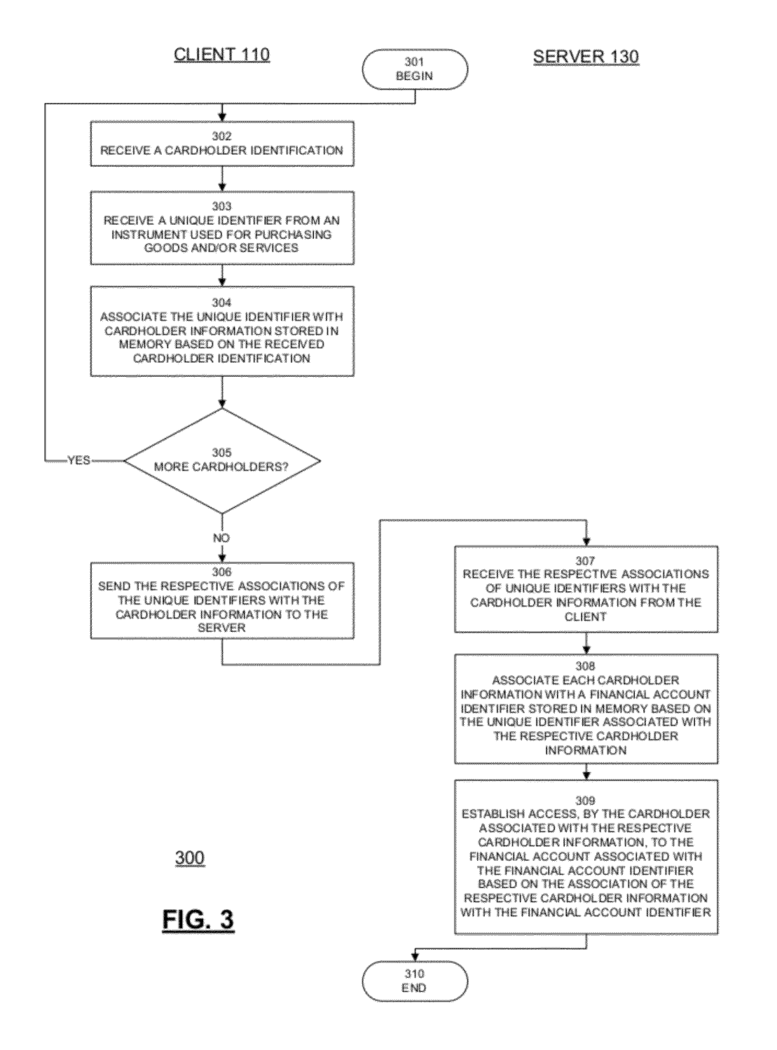

Turning now to FIG. 3, an exemplary process 300 is illustrated for disbursing funds in accordance with the architecture 100 of FIG. 1. The process 300 proceeds from beginning step 301 to the client 110 side in step 302, in which a cardholder identification is received, and in step 303, in which a unique identifier from an instrument 200 used for purchasing goods and/or services is also received. In step 304, the unique identifier is associated with cardholder information stored in memory 120 based on the received cardholder identification. In decision step 305, if there are more cardholders to provide cardholder identification and unique identifiers, the process 300 returns to step 302, otherwise the process 300 proceeds to step 306. In step 306, the respective associations of the unique identifiers with the cardholder information are sent from the client 110 to the server 130.

Turning to the server 130 side, in step 307 the server 130 receives the respective associations of the unique identifiers with the cardholder information from the client 110. In step 308, the cardholder information for each cardholder is associated with a financial account identifier stored in the memory 132 of the server 130. Finally, in step 309, access for the cardholder associated with the respective cardholder information is established to the financial account associated with the financial account identifier based on the association of the respective cardholder information with the financial account identifier. The process 300 ends in step 310.

Having set forth in FIG. 3 an exemplary process 300 for disbursing funds in accordance with the architecture 100 of FIG. 1, an example will now be described using the exemplary process 300 of FIG. 3 and an institution, Mobius University, that has received 250 instruments 200 to distribute to 250 new students (i.e., cardholders) so that the students can access their financial aid funds in the financial account associated with the instruments 200.

A university, Mobius University, with a physical campus has an incoming freshman class of 250 students. Although Mobius is described as having a physical campus, the disclosed system is configured to work with institutions having a virtual campus or no campus at all. Mobius University has received, from the government, financial aid for each of the 250 students. Mobius University may also have payroll, stipends, and/or wages to pay to some of the 250 students. Mobius University seeks to quickly provide to each of the students a single instrument 200 with which the student can identify themselves, access their financial aid, or purchase goods and/or services on campus, or purchase goods and/or services off campus, or gain access to the restricted physical spaces on campus or to electronic devices maintained by the university. Mobius University has information for each of the students on campus electronically stored as cardholder information 122 in memory 120. The cardholder information 122 was obtained based on information provided by the students to Mobius University when applying and accepting admission to Mobius University, or updated thereafter. Mobius University has asked an agent of a financial institution, Anytown Bank, to provide them an instrument 200 for each of the 250 students that satisfies Mobius University's requirements. In response, the agent has mailed to Mobius University 250 instruments 200 (or “Mobius cards,” as discussed with reference to this example). Each Mobius card 200 is substantially identical to the instrument 200 illustrated in FIG. 2. Each Mobius card 200 that Mobius University receives is a two-sided 210 and 230 physical card that includes, on a first side 230, an open-loop magnetic stripe 232, and/or a closed-loop magnetic stripe 234, and/or a proximity chip 236 embedded in the card, and on a second side 210 includes an identification 218 of Mobius University, a financial account identifier and expiration date 216, and an identification of the financial institution 220 responsible for managing access to the financial account. Notably, each Mobius card 200, when received at Mobius University, may not include a photograph 212 of the student or the student's name 214, as a student has not yet been assigned to the Mobius card 200. In some instances, the card will be mailed personalized with a photograph of the cardholder and the cardholder's name and/or financial account identifier.

On the first day of attendance for the 250 students, Mobius University establishes a clerk at a kiosk on campus that includes a client 110 connected to a server 130 at Anytown Bank over the network 150. Each of the 250 students visits the kiosk for on-site issuance of their Mobius card 200, at which the process 300 of FIG. 3 occurs. The process 300 proceeds from beginning step 301 to the client 110 side in step 302, in which a first student, Mary Jane, may provide a form of identification, such as her social security number “123-45-1230”. The social security number is entered into the client 110 by the clerk using a keyboard of the input device 116, a combined keyboard and magnetic stripe reader. As discussed above, a contactless Near Field Communications (NFC) reader can be used where applicable. In step 303, the clerk may swipe the closed loop magnetic stripe 234 of the first Mobius card 200 from the stack of 500 Mobius cards 200 through the magnetic stripe reader of the input device 116 to obtain the unique identifier associated with the Mobius card 200. In some instances, the card 200 will be automatically swiped by the input device 116 without human intervention. The client 110 reads the unique identifier as “12345673,” and then deletes the unique identifier from the closed loop magnetic stripe 234 of the Mobius card 200, replacing it with an identifier specific to Mobius University. Importantly, Mobius University does not read or encode the open loop magnetic stripe 232, thereby avoiding governmental and industry compliance issues. In step 304, the client 110 identifies Mary Jane's social security number “123-45-1230” as being associated with an entry in the cardholder information 122 stored in the memory 120 of the client 110, entry number 176, because entry number 176 includes the social security number “123-45-1230” from when Mary Jane applied to Mobius University. The client 110 then takes the relevant information for Mary Jane from entry 176 and associates it with the unique identifier “12345673” from the Mobius card 200.

In an optional step, depending on the needs of the educational institution or financial institution, Mary Jane is asked to accept the terms and conditions associated with the Mobius card 200. Once she accepts the terms and conditions, the Mobius card 200 is personalized by printing (e.g., using output device 114, a printer) her name and designation 214 as well as her photograph 212 on the card. Once the Mobius card 200 is personalized, the clerk gives Mary Jane the Mobius card 200 and tells Mary Jane that her financial account identified on the Mobius card 200 will be activated once she calls Anytown Bank, and that her financial aid will be deposited in that financial account upon Mobius University beginning the disbursement process. Mary Jane will be able to access her account at Anytown Bank locations, online through an appropriate web interface, or through a mobile device. In certain embodiments, funds can be transferred between the open loop account and the closed loop account using an appropriate electronic (e.g., Internet) interface. Mary Jane is also told that she now has access to otherwise restricted locations and devices on campus due to the contactless chip 236 and magnetic stripe 234 on her Mobius card 200. In decision step 305, if there are any additional students in line at the kiosk waiting for their Mobius card, steps 302 to 304 repeat for each remaining student.

In step 306, the respective associations for all students processed at the kiosk of the unique identifiers, including Mary Jane's unique identifier “12345673,” with the corresponding cardholder information (e.g., the cardholder identification number, full name, address, date of birth, telephone number, and email for each cardholder, including Mary Jane), may be encrypted into a file and placed on an SFTP site over the network 150. In step 307, the server 130 at Anytown Bank retrieves and decrypts the file from the SFTP site over the network 150 at a predetermined time according to a predetermined schedule.

In step 308, the processor 136 of the server 130 at Anytown Bank associates the cardholder information for each student with the financial account identifier 216 (e.g., for the financial account) stored in the memory 132 of the server 130. Finally, in step 309, after Mary Jane calls Anytown Bank and provides an activation code (e.g., the financial account identifier 216 and her date of birth, via input device 140, a telephone) that is verified with the cardholder information received by Anytown Bank from the client 110 in step 307, Mary Jane's access to the financial account 216 identified on her Mobius card 200 is activated, as are the accounts of the remaining students once they provide their activation codes. The process 300 ends in step 310. Soon thereafter, Anytown Bank transfers the financial aid, wages, stipend, and/or payroll for each of the students into each of their respective financial accounts associated with their respective Mobius cards. The students are then able to use their financial aid money to purchase goods and services using the open loop magnetic stripe 232 (e.g., at off-campus merchants) and the closed loop magnetic stripe 234 (e.g., at Mobius university and other on-campus merchants) and contactless chip 236.

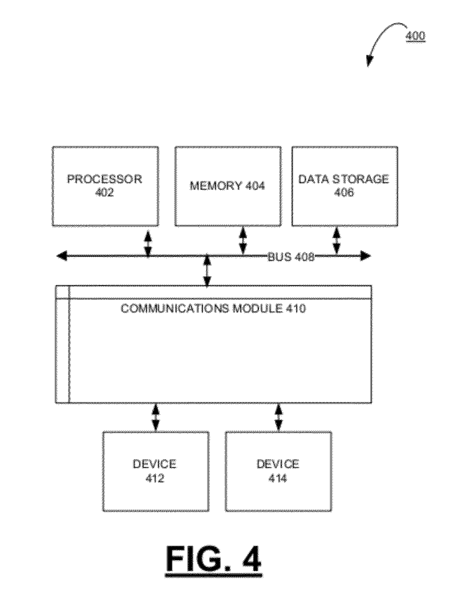

FIG. 4 is a block diagram illustrating an example of a computer system 400 with which the client 110 and server 130 of FIG. 1 can be implemented. In certain embodiments, the computer system 400 may be implemented using software, hardware, or a combination of both, either in a dedicated server, or integrated into another entity, or distributed across multiple entities.

Computer system 400 (e.g., client 110 or server 130) includes a bus 408 or other communication mechanism for communicating information, and a processor 402 (e.g., processor 112 or 136) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. Computer system 400 also includes a memory 404 (e.g., memory 120 or 132), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The instructions may be implemented according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402. Computer system 400 further includes a data storage device 406 such as a magnetic disk or optical disk, coupled to bus 408 for storing information and instructions. Computer system 400 may be coupled via communications module 460 (e.g., communications module 118 or 138) to various devices (not illustrated). The communications module 410 can be any input/output module. In certain embodiments, the communications module 410 is configured to connect to a plurality of devices, such as an input device (e.g., input device 116 or 140) and/or an output device (e.g., output device 114).

According to one aspect of the present disclosure, the client 110 or server 130 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative embodiments, hard-wired circuitry may be used in place of or in combination with software instructions to implement various embodiments of the present disclosure. Thus, embodiments of the present disclosure are not limited to any specific combination of hardware circuitry and software.

The term “machine-readable storage medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read.

The embodiments of the present disclosure provide systems and methods in which an institution, in association with a bank, can issue an instrument to a cardholder and disburse funds to a financial account associated with that instrument. The systems and methods are accomplished through the use of a unique identifier associated with that instrument and without the institution having to read any financial account information, thereby avoiding subjecting the institution to certain state and federal laws and industry regulations governing the disbursement of funds to cardholders.

While certain aspects and embodiments of the invention have been described, these have been presented by way of example only, and are not intended to limit the scope of the invention. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. A system for disbursing funds, comprising:
a memory for storing cardholder information; and
a processor configured to receive a cardholder identification, to receive a unique identifier from an instrument used for purchasing at least one of goods and services, to associate the unique identifier with the cardholder information based on the received cardholder identification, and to send the unique identifier and the cardholder information to a server.

2. The system of claim 1, wherein the processor is further configured to remove the unique identifier from the instrument after the unique identifier is received.

3. The system of claim 1, wherein the cardholder identification is received from an input device.

4. The system of claim 3, wherein the input device comprises a magnetic stripe reader, a barcode reader, a radio frequency identification (RFID) reader, a contactless NFC reader, or a desktop card encoder.

5. The system of claim 1, wherein the unique identifier is received from a closed loop information storage of the instrument.

6. The system of claim 5, wherein the processor is further configured to store a closed loop identifier on the closed loop information storage of the instrument.

7. The system of claim 1, wherein the cardholder information comprises a date of birth.

8. The system of claim 8, wherein the cardholder information further comprises at least one of a cardholder identification number, name, mailing address, phone number, or email address.

9. A method for disbursing funds, comprising:
receiving a cardholder identification;
receiving a unique identifier from an instrument used for purchasing at least one of goods and services;
associating, using a processor, the unique identifier with cardholder information stored in memory based on the received cardholder identification; and
sending the unique identifier and the cardholder information to a server.

10. The method of claim 9, further comprising removing the unique identifier from the instrument after the unique identifier is received.

11. The method of claim 9, wherein the cardholder identification is received from an input device.

12. The method of claim 11, wherein the input device comprises a magnetic stripe reader, a barcode reader, a radio frequency identification (RFID) reader, a contactless NFC reader, or a desktop card encoder.

13. The method of claim 9, wherein the unique identifier is received from a closed loop information storage of the instrument.

14. The method of claim 13, further comprising storing a closed loop identifier on the closed loop information storage of the instrument.

15. The method of claim 9, wherein the cardholder information comprises a date of birth.

16. The method of claim 15, wherein the cardholder information further comprises at least one of a cardholder identification number, name, mailing address, phone number, or email address.

17. A machine-readable storage medium comprising machine-readable instructions for causing a processor to execute a method for disbursing funds, comprising:
receiving a cardholder identification;
receiving a unique identifier from an instrument used for purchasing at least one of goods and/or services;
associating, using a processor, the unique identifier with cardholder information stored in memory based on the received cardholder identification; and
sending the unique identifier and the cardholder information to a server.

18. A system for disbursing funds, comprising:
a memory for storing a financial account identifier associated with a financial account; and
a processor configured to receive a unique identifier of an instrument used for purchasing at least one of goods and services, to receive cardholder information associated with a cardholder, to associate the cardholder information with the financial account identifier based on the received unique identifier, and to activate access to the financial account by the cardholder based on the association of the cardholder information with the financial account identifier,
wherein the financial account identifier and the unique identifier are different.

19. A method for disbursing funds, comprising:
receiving a unique identifier of an instrument used for purchasing at least one of goods and services;
receiving cardholder information associated with a cardholder;
associating, using a processor, the cardholder information with a financial account identifier stored in memory based on the received unique identifier; and
activating access to the financial account by the cardholder based on the association of the cardholder information with the financial account identifier,
wherein the financial account identifier and the unique identifier are different.

20. A machine-readable storage medium comprising machine-readable instructions for causing a processor to execute a method for disbursing funds, comprising:
receiving a unique identifier of an instrument used for purchasing at least one of goods and services;
receiving cardholder information associated with a cardholder;
associating, using a processor, the cardholder information with the financial account identifier based on the received unique identifier; and
activating access to the financial account by the cardholder based on the association of the cardholder information with the financial account identifier, wherein the financial account identifier and the unique identifier are different.
